(19) United States
(12) Patent Application Publication
(10) Pub. No.: US 2007/0043583 A1
(43) Pub. Date: Feb. 22, 2007

(54) Reward driven online system utilizing user-generated tags as a bridge to suggested links

(75) Inventors: Hasan Davulcu, Phoenix, AZ (US); Prabhdeep Singh, Tempe, AZ (US); Thomas Duening, Maricopa, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Arizona Board of Regents on behalf of Arizona State University, Tempe, AZ (US)

(21) Appl. No.: 11/373,832

(22) Filed: Mar. 10, 2006

Related U.S. Application Data
(60) Provisional application No. 60/661,187, filed on Mar. 11, 2005.

(51) Int. Cl. G06Q 99/00

(52) U.S. Cl. 705/1

(57) ABSTRACT

A web site for user suggestions of products, services or other information. The Suggestor also submits tags with those suggestions. To the extent subsequent users use the same tags to access or purchase the user suggestion, the suggesting user will be rewarded. The present invention also provides mechanisms for disbursing rewards for “finding-and-buying-thru-tags”, ranking suggestions, enabling various privacy preserving communications and deal validation mechanisms among shoppers, Suggestors and their social networks.

### CROSS-REFERENCES TO RELATED APPLICATIONS

This application claims priority from provisional application No. 60/661,187, entitled “A Reward-Driven Suggestion-Portal Creation and Management Method for Online Products and Services,” filed on Mar. 11, 2005.

### BACKGROUND OF THE INVENTION

The present invention relates to the organization of user suggestions of products, services and information on the Internet.

An Internet shopper can search for a desired product, for example running shoes, by entering keywords (“tags”) into a search engine, such as Google or Yahoo, or by sifting through articles or blogs that mention running shoes and other relevant material. If the shopper knows a particular store, the shopper can search the site of that store. Also, the shopper can search online malls for products from multiple affiliated stores.

Internet shoppers can also use a software program or agent known as an Internet robot or ‘bot’, or a web crawler (a crawler is described, for example, in U.S. Pat. Nos. 6,785,671 and 6,714,933) to conduct searches. Another source of products is online auctions. Some online auction sites allow shoppers to enter feedback about sellers. Shoppers can also read product reviews at review sites, such as epinions or Amazon. Some online malls link shoppers to these product-specific reviews. Shoppers can post reviews and comments about products on the Internet. Newsgroups have traditionally been used by shoppers to post comments about various products.

U.S. Pat. No. 6,405,175 shows individuals making suggestions about products, with hyperlinks to those products. Rewards for the person making a suggestion are based on subsequent click throughs. Revenue and rewards generated by click throughs is shown to be vulnerable to click-fraud (in which unscrupulous competitors create programs to click on ads repeatedly and cost an advertiser more money).

Yub.com teaches users to post suggestions on their own profile pages (own web pages). This is described in US Published applications 20050234781, 20050203801, 20050160094, and 20050149397.

Beenz.com, mypoints.com and Amazon's mturk.com prescribe work defined by tasks, such as reading emails, visiting web sites, enriching product information or associating images with addresses. They compensate the completion of such piece-wise activity with cash or reward points that are redeemable as discounts or free products or services. This is described in US published application no. 20040073483 (see also Beenz.com published application no. 20020082918).

Fatwallet, Shopping.com, E-Bates and a number of other comparison shopping sites provide cash-back incentives which are activated only when a user purchases a product through one of these sites.

Amazon provides a review submission mechanism, on their list of offerings, but they do not provide any reward mechanism for reviewers. Epinions also provides a review submission mechanism for its own list of posted products and a reward mechanism, named “income share”, for reviewers. The income share pool is a portion of Epinions' income. The pool is split among all authors based on how often their reviews were used in making a decision (whether or not the reader actually made a purchase). Income Share is determined by a formula that automatically distributes the bonuses. The exact details of the formula must remain secret in order to limit attempts to defraud the system. Users have no direct means of sharing their alternative product suggestions nor are they rewarded for their suggestions from outside the e-opinions portal.

Microsoft has a family of applications which describe putting software on the desktop and capturing recommendations in email and documents, and rewarding on that basis (US published application nos. 20020007309, 20020029304, 20020035581, 20020087591 and 20020198909). The applications describe the “smart tags” used in Microsoft Office. The software parses the data in a document or email and annotates it with the relevant URLs. E.g., IBM mentioned in a word document automatically becomes a link to www.ibm.com. These smart tags are basically treated as cookies to track the users. The more cookies someone has (of a particular site) the better candidate he/she is for a promotion. So if a person has a document that mentioned IBM 20 times it amounts to advocating IBM and the author will be offered incentives by IBM.

In order for the Microsoft software to recognize a concept type and tag it correctly, it must have some prior domain knowledge (e.g., it must recognize that IBM has a website ibm.com). It may be sufficient for Microsoft Office to capture a finite number of office related concepts, however for suggestions of deals on the Internet, by definition many of those sites will be new and it is not practical to include them in a program.

A number of recent “social media” web companies offer up to 100% of the ad revenues generated from web pages that contain user contributions on any topic. Examples are:

Newswine—This site allows readers to create their own Newswine web pages on a specific topic. Readers submit their own written stories or become editors by creating their own Newswine pages on a specific topic. Participating contributors and editors keep 90% of ad revenues generated by their pages.

Squidoo.com—This site allows users to create aggregated web pages, called “lenses”, on any topic. Lenses contain user profile information. Participating contributors and editors will get to keep 100% of ad revenues (and click through and affiliate income) generated by their web pages.

Clipfire.com—This site allows users to submit affiliate links and earn affiliate income.

Kaboodle.com (similar to Wists.com and Yahoo's Shoposphere)—This site is a free social book-marking service. It was introduced in fall 2005. After registration, a user can download a button to her browser from the Kaboodle web site. Whenever the user clicks on the button, a segment of the content from any web page is automatically identified as the product information. This automated capture mechanism may yield inaccurate or incomplete product information. The user is then asked to manually enter tags and a review. A user's suggestions are then listed from her public profile and made available to others using standard keyword search. No reward mechanism is provided for the users.

### BRIEF SUMMARY OF THE INVENTION

The present invention provides in one embodiment a mechanism for users to suggest products, services or other information. The tags or groups of tags that the user (Suggestor) used to find the suggestions are captured and stored. Subsequent users who use the same tags will access the Suggestor's suggestion.

In addition to products, services, and other information, Suggestors may also suggest bundles of products (such as products required for a “romantic picnic”), bundles of services (such as “home repair specialists”), bundles of products and services (such as “Genie garage door openers and installers”), bundles of products and information (such as Hoover vacuum cleaners and product reviews), bundles of services and information (such as a local plumbing contractor and reviews of its service), or other information to a plurality of other Internet users for the purposes of earning cash or other types of rewards. In one embodiment the invention inextricably connects the Suggestor, tags, and a specific online link to a product, service, or other information. The invention automatically tracks the search terms (tags) the Suggestor used to find the item of interest (product, service, or other information) on the Internet. The invention also provides a mechanism for the Suggestor to upload the product or service item of interest to a web-based “suggestion portal.” The invention also prompts the Suggestor to submit additional search related tags with a particular suggestion. When subsequent users (Shoppers) who visit the suggestion portal use the same tags to access and purchase or otherwise act upon the Suggestor's suggestion, the Suggestor will earn a reward that is a pre-defined percentage of the commission generated from the Shopper's actions.

The invention addresses the problems of Shopper difficulties with keyword searches when looking for a product, or looking for a service or other information on the Internet. It is often difficult for shoppers to determine the best keywords (“tags”) to use to find desired items. Often, search results come back with literally thousands or millions of hits to sort through. The present invention essentially captures a “word of mouth” suggestion, combined with the tags another user (the Suggestor) had initially tried. In one embodiment, even if the tags aren't the ones that eventually located the product, the tags are associated with the product because that is what the Suggestor tried first, and likely are what Shoppers would try first. As this system tracks and stores the Suggestor's original tags, and prompts the Suggestor to add additional intuitive tags, the online Shopper has an improved chance of identifying desired products, services, or other information, and doing so more quickly, than existing search tools and methods allow.

In one embodiment, the Suggestor is informed if the suggestion has already been made by another Suggestor, in which case the Suggestor will not receive rewards. However, if the Suggestor provides new tags associated with the product, the Suggestor will receive rewards to the extent those tags are actually used by Shoppers to locate a product, service or other information within the suggestion portal.

The invention also provides a word of mouth, or viral, marketing system. The suggestions can spread through social networking on the web. Essentially, the system assembles users into a collection of loosely federated salesmen for affiliated vendors, thus contributing to online “hubs of influence” to increase the traffic and conversion at affiliated vendors.

The present invention also provides mechanisms for disbursing rewards for “finding-and-buying-through-tags”, ranking suggestions, enabling various privacy preserving communications and deal validation mechanisms among Shoppers, Suggestors and their social networks.

The present invention in one embodiment provides the ability to incorporate any ad hoc or new category on the fly for shopping applications. In many realistic domains, such as shopping, there will be a variety of new items and categories introduced to Shoppers. In creating and uploading suggestions, anything that catches a user's attention that has a market is a fair game for tagging. Software is limited in dealing with ad hoc categories in arbitrary domains, and thus the present invention takes advantage of a human selected tag with a reward mechanism as an incentive for the Suggestor.

### BRIEF DESCRIPTION OF THE DRAWINGS

FIG. 1 is a diagram illustrating the overall operation of an embodiment of the invention.

FIG. 2 is a diagram of a suggestion button added to a browser according to an embodiment of the invention.

FIG. 3 is a diagram of an embodiment of a page displayed when a user's tag search directly matches a popular tag.

FIG. 4 is a diagram of the software modules in suggestion software according to an embodiment of the invention.

FIG. 5 is a block diagram of the suggestion website software according to an embodiment of the invention.

FIG. 6 is a diagram of an embodiment of the interaction of Suggestors and Shoppers over the Internet with the Suggestion website.

### DETAILED DESCRIPTION OF THE INVENTION

Overview

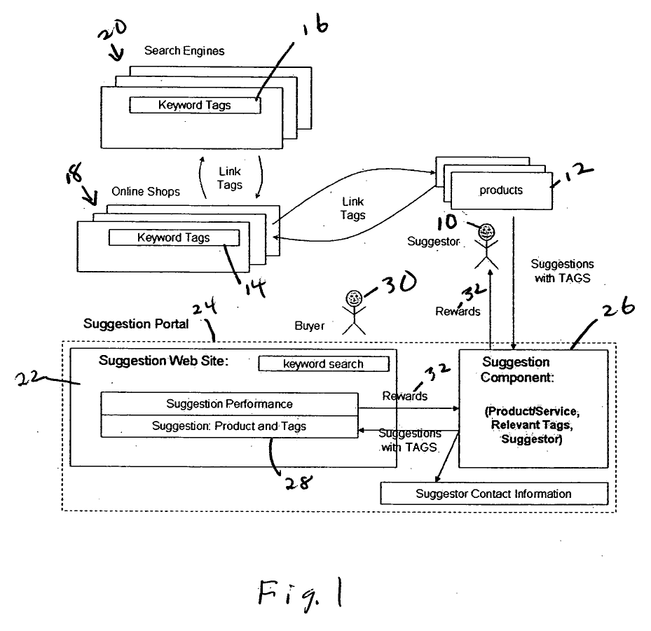

FIG. 1 illustrates the operation of an embodiment of the present invention. A Suggestor 10 searches on the Internet for products 12 using tags 14, 16. The Suggestor can search in various ways, such as using online shops 18 or search engines 20. The Suggestor tries various tags and looks at various links until a relevant product, service, or other information is discovered. The product, service, or other information can be relevant based on price, features, or other aspects.

The Suggestor then submits the deal (product or service) as a suggestion to the suggestion web site 22 thru suggestion portal 24. The suggestion 26 includes 3 components: (1) a link to the suggested product/service, (2) the relevant tags used in the searches to find the link, and (3) an identification of the Suggestor. The suggestion with its tags is compared to existing suggestions. If the link is new, or if there are new tags for an existing link, the suggestion is accepted and stored in a memory 28.

A Shopper 30, a subsequent user, will visit the suggestion portal web site 22. If the Shopper uses a tag submitted by the Suggestor to purchase a product/service at a link provided by the Suggestor, rewards 32 will be provided to the Suggestor 10.

An embodiment of the invention may be implemented as a suggestion portal which comprises (1) a browser or a desktop component that tracks tags and enables submission of a suggestion., sometimes called the client suggestion module herein and (2) a suggestion website on a server connected to the world-wide-web or Internet. The suggestion web site contains a wide variety of products with their commercial and technical attributes. The client suggestion module is software that aids in the development and submission of suggestions by Suggestors.

Tracking Tags

The client suggestion module enables a Suggestor to electronically submit a suggestion and all associated tags, by simply highlighting the product information on any web page and by selecting or inputting product associated descriptive tags. The client suggestion module can be disseminated and invoked by any kind of electronic media.

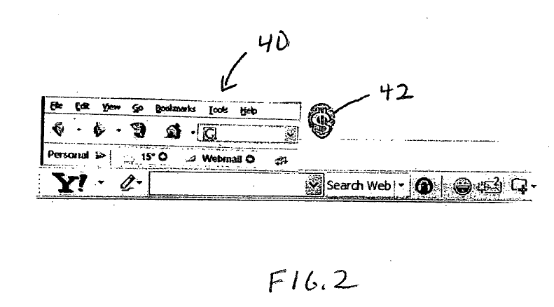

FIG. 2 shows one embodiment of a user browser toolbar 40 which includes a suggestion button 42. Button 42 is downloaded with tracking software for assisting a Suggestor. The software will track the URLs, or links, visited by a Suggestor using the browser. The tags used by the user in the search are recorded, including tags in the links themselves. In particular, the grouping of tags used in a search is recorded. When the user settles on a link and wishes to make a suggestion, the user simply clicks on suggestion button 42.

When suggestion button 42 is clicked, it will record the present webpage as the link for the suggestion. It will associate with that link all the tags used in the search. Additionally, it will associate information identifying the Suggestor. These 3 elements together form a suggestion component, which is then uploaded to a suggestion website as illustrated in FIG. 1.

The software can also scrape information from the webpage being submitted to identify the product, service or information on the website. For example, it may record commercial and technical attributes. Commercial attributes may include information such as product name, product URL, image URL, price, description, brand, category and availability. Technical attributes may include detailed specifications of technical product features such as size, weight, color, material. This data may be presented to the Suggestor to verify first, or may be automatically uploaded. Alternately, the Suggestor may highlight parts of the webpage to include, and the software can include the highlighted information in addition to, or instead of, the automatically captured information.

The highlighted or automatically captured product information can be checked against the product catalog of the affiliated vendor. If a match is found in the product catalog of the vendor then the more accurate and complete product information, such as the product name, description, image, brand, price, SKU number, affiliate link and other technical attributes, is used as the product information rather than the user highlighted or automatically extracted information available on the web page. This allows a later parametric search by brand, price and the other attributes captured. User highlighted or automatically extracted information can be incorrect and incomplete since a user may not highlight an important piece of information or the extraction algorithm may select the incorrect or incomplete segments of information from a web page.

In another embodiment, a whole toolbar may be added to the user's browser instead of just a single button. The additional buttons can activate different features. For example, one button could link to the suggestion website. Another button may bring up a list of prior, incomplete searches that did not result in a suggestion. The toolbar may report in real time the total rewards earned from a user's suggestions, it may also contain a button to the detailed earnings report. The toolbar might contain an indicator that a shopper may need the assistance of a Suggestor based on a tag or product suggested by the Suggestor. The toolbar may also display other online users so that Shoppers may communicate among themselves or with the online or offline Suggestors using real time communication mechanisms such as instant messaging, VOIP or regular telephone calls with or without co-browsing, or asynchronous communication mechanisms such as anonymous email, message boards or voice mail exchange. The toolbar may also be used by Shoppers or Suggestors to retrieve deals from the suggestion web site while shopping online at another web site. In this case the suggestion web site may be used as a validation authority for ensuring the soundness of a deal found online or offline at another shop.

In another embodiment, instead of a button or toolbar, a cookie is loaded onto the Suggestor's computer. The cookie records the tags and associated links during searching by the Suggestor. A separate cookie could be provided for each of a number of key websites. When the Suggestor subsequently returns to the suggestion website, the cookie can be inspected to determine the tags and link. The link can then be visited to capture the desired commercial and technical information. Alternately, any other method of tracking tags and links may be used.

In another embodiment, the Suggestor first visits the suggestion website, and from there pulls up the site of a search engine, shopping mall, merchant site or other website for searching for products, services or information. The suggestion website then tracks the Suggestor's tags and links. In this, and the above methods, the tracked information may be discarded if the Suggestor submits a corresponding suggestion within the same session or within some time period. Alternately, the information may be saved until the Suggestor indicates it should be deleted, such as by allowing a Suggestor to save an incomplete search for another day.

In another embodiment, instead of, or in addition to, the above options, the Suggestor can cut and paste or type in suggestion information from a vendor site, including tags, links and product information into a form available in the suggestion web site. The Suggestor will be prompted to arrange the tags in groups that would be used in a search, not just input them separately.

Online users spend significant time and effort to find matching items for their needs. Following the 80/20 rule, it has been noted that 80 percent of web users search for 20 percent of searched items. The terms people type into Internet search engines everyday are called tags. There are thousands of tags that are used by Internet users for querying search engines. Popular tags are sets of search phrases that are frequently used to search. Popular tags are typically 2 to 3 word phrases. For example, in conducting searches online for specific products some popular tags might be: portable humidifiers, red rugs, garden lighting, running shoes, GE dishwashers, high efficiency washers, etc.

When entered into a search engine, tags generate returns based on the algorithms used by the particular search engine. No two search engines will produce the same returns. There currently is no automated solution that produces only high relevance results for even the popular tags. Normally an individual using a standard Internet search engine will try various different tags phrases and follow various “links” before locating a matching product or service. People searching for items while shopping online fare no better than anybody else when trying to generate relevant results using standard search engines. For example, a person who enters a tag such as “garden lighting” will generate thousands of resulting “hits”, but there is no quick or automatic way to sort the list for personal relevance. The ideal would be to find the entire garden lighting range of products available on the web in one location, and also be able to determine which garden lighting items other people are buying and their pre-sale and post-sale experiences.

This invention provides a method for Suggestors to register, publish and share their findings with a plurality of online shoppers. Product associated tags are identified by the Suggestor using the client suggestion module. The client suggestion module automatically creates a list of candidate tags as a result of recording a Suggestor's online searching interactions, such as his/her tag search phrases, URLs for the links that he/she visits, and other tag phrases during form fill-outs—at various search engines and vendor web sites. The client suggestion module can also query various other relevant tag or phrase databases. Users can formulate various tag searches against those databases to retrieve additional relevant tags for their product suggestion.

The suggestion web site can also be searched using the client suggestion module without visiting the suggestion web site. Upon a Shopper's request, the client suggestion module can be configured to automatically search the suggestion web site with user determined tags or parametric searches and return relevant matches and suggested items in real time. If the Shoppers tag search directly matches a popular tag associated with suggested products by various Suggestors then the suggestion web site will return to the Shopper the corresponding group of suggested products, their associated reviews and other suggested related tags. This tool can be provided to both the Suggestor looking for product deals, and to a Shopper.

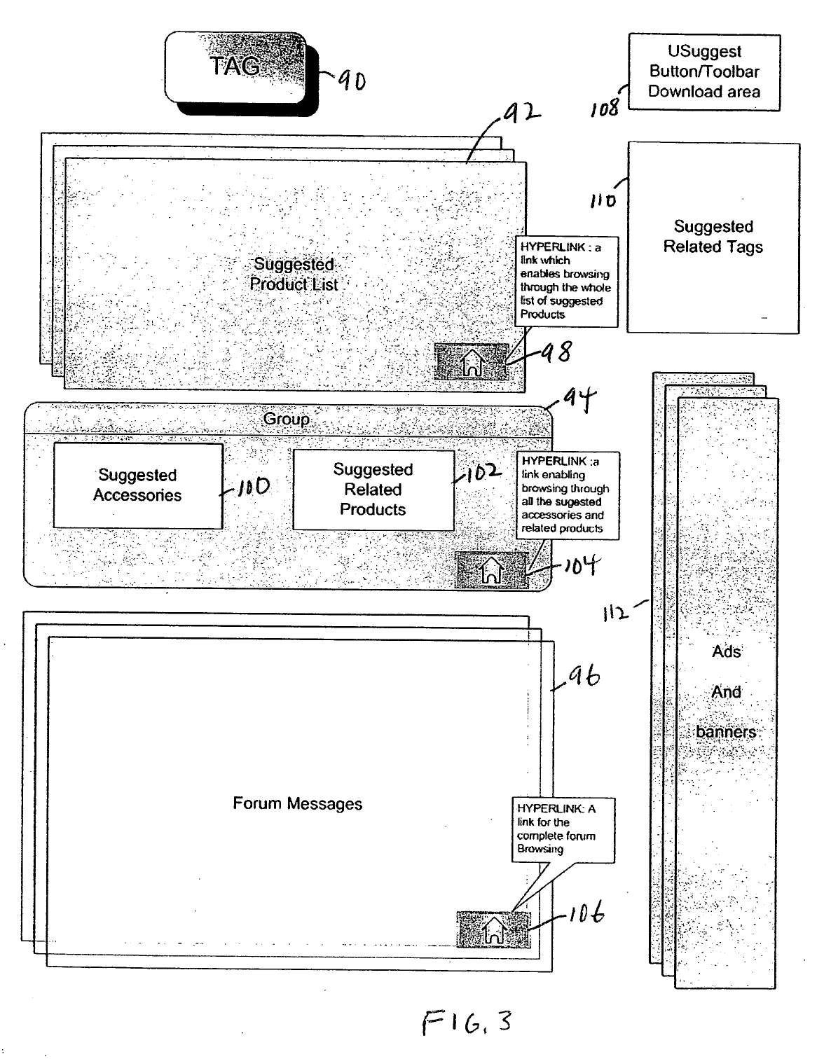

FIG. 3 shows an embodiment of the user interface presented to the Suggestor. A tag 90 is displayed along with a suggested product list 92, a group 94 and forum messages 96. The suggested product list will display all products associated with tag 90. A hyperlink 98 enables browsing through the whole list of suggested products.

Group section 94 displays suggested accessories 100 and suggested related products 102. One or more hyperlinks 104 provide a link to those related product and accessory pages. Forum messages section 96 displays reviews and comments by other users, with one or more hyperlinks 106 providing a link to those pages.

Also provided is a button/toolbar download area 108. Suggested related tags 110 are presented. Finally, the page can include ads and banners 112 that are related to the tag 90 or any other information on the page or linked pages.

The client suggestion module can be enabled or disabled upon a user's request. The highlighting based registration mechanism built in the client suggestion module ensures that only valid product information from shopping or services web sites can be posted as suggestions.

Suggestion Components

As noted above, a suggestion has 3 components:

(1) Link. The link to the product, service or other information. In different embodiments, this also includes commercial and technical information. The link could be input by any of the means discussed above. The Suggestor can highlight additional information from the webpage to include in the corresponding suggestion, and/or the Suggestor can enter additional information. Additionally, the Suggestor can correct or modify information that has been automatically captured by the system.

(2) Tags. These tags can be captured by any of the means discussed above. Additionally, the Suggestor may type in or cut and paste additional tags. Also, the suggestion software can suggest other possible tags based on the tags, link, or commercial or technical information submitted. The Suggestor can be given the opportunity to accept or reject the suggested tags.

(3) User identification. The suggestion website stores some sort of ID information to identify the Suggestor. This could be an email address, so the Suggestor can be notified of earned rewards. It could be some other unique code, with it being up to the Suggestor to log on with the code to determine if any rewards have been earned. In one embodiment, the Suggestor ID information is not presented with the suggestion to subsequent users, or is presented in a form which protects the Suggestor's privacy. The Suggestor identification information can be captured during a registration process where the Suggestor provides desired information. The registration could be done when the Suggestor first visits the suggestion website, or could be done by prompting the Suggestor at the time of the first suggestion submission.

Suggestion Submission, Acceptance

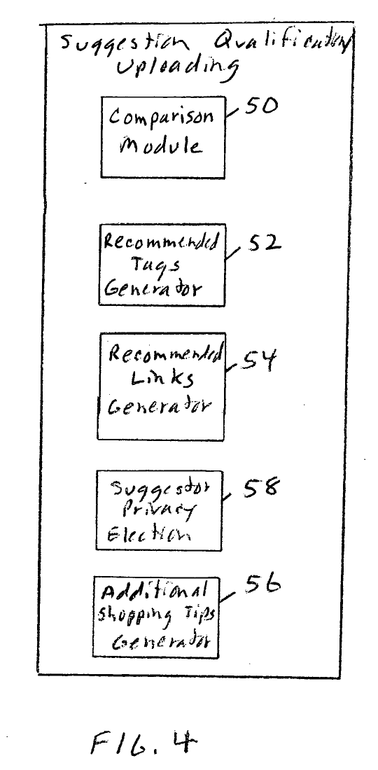

FIG. 4 is a diagram of the suggestion acceptance software modules or elements. A suggestion is submitted by the Suggestor, with the suggestion components, as described above. In one embodiment the suggestion software also performs the following functions:

Comparison to previous suggestions. The suggested link and tags are compared to previously suggested links and tags by a comparison module or engine 50. The Suggestor is informed if the suggestion has already been made, or if some or all of the tags have already been suggested.

Additional recommended tags. Additional possible tags are presented to the Suggestor by a recommended tags generator module 52. This allows the Suggestor to decide whether to add those tags to his/her suggestion. This represents an improvement over prior art which describes the automatic adding of tags Automated systems are not good at determining tag relevance to actual shoppers. The task of determining relevance is still best done by people acting in their own self interest. The additional tags can be generated in any number of ways. For example, the tags provided by the Suggestor can be compared to other tags for other existing links on the suggestion website. If there is a match, the other tags for that existing link are presented to the Suggestor. The Suggestor can then decide whether to add them to the suggestion. Additionally, the software can query a tag or phrase database that stores related words and phrases, and present those to the Suggestor. The Suggestor can also formulate searches of those databases to try to find additional tags. The Suggestors can thus hyperlink their tags to other related tags so that their suggestions can be found from other relevant categories. This leads to a rich and useful linking within the suggestion website.

If a certain tag has already been associated with the user's suggested product then it is not accepted as a suggestion, since duplicate tags are not allowed. For example, a user might search “oriental bedding” at a search engine, and then might get to a page where he/she clicks on a link with a label “Chinese bedding” to reach a set of products. If the user finds a matching product that he/she likes then she can use the client suggestion module to tag that product with both “oriental bedding” and “Chinese bedding”. If “oriental bedding” has already been suggested, it won't be accepted, but “Chinese bedding” will be accepted. The client suggestion module can also be used to retrieve additional tags matching “bedding”. Upon eyeballing the tags matching “bedding”, the user might identify additional relevant tags such as “Asian bedding” and “blue bedding” or “blue Asian bedding”.

Tag Dissemination. In one embodiment, tags on the suggestion website can be disseminated. An RSS (real simple syndication) mechanism is built into every page so that it is easy for users to get updates on the pages they would like to track. For example, a user can subscribe to a feed on the “titanium woods” page so that as soon as anyone makes a change on that page it is pushed into the user's browser or other device such as a cell phones. The RSS mechanism can also be used to “market” tag pages into Technorati and other social networking platforms. This allows the suggestion website pages to be easily incorporated into the blogs that would like to talk about them.

Related products and other links. A recommended links module 54 can recommend possible related hyperlinks to the Suggestor in the same manner as the recommended tags. Links previously related to similar links or tags can be presented to the Suggestor, to accept or reject. Again, this allows human review of the automatically generated possible links. Alternately, links could be automatically generated or added by administrative personnel. The Suggestor could search the suggestion website for possible related links, reviewing recommended links and search terms in the process. In addition to links to related products, other relevant information that might be of interest to a future buyer may be in the same or alternate manners. For example, an additional information module 56 may assist the Suggestor in generating shopping tips, topic or group names, coupons, deals and URLs or other relevant web pages and user reviews.

The Suggestor has the option of associating a suggestion with any category, tag or topic of his/her selection within the suggestion portal to increase the findability of the suggestion. The suggestion-portal may also automatically place a user's suggestion under other relevant categories.

Suggestor privacy. A Suggestor privacy module 58 in one embodiment provides the Suggestor with options regarding the Suggestor's identity. Maintaining the Suggestor's privacy is the default mode. The suggestion portal maintains the privacy and anonymity of the Suggestor from other portal visitors. Alternately, the Suggestor may elect to have the Suggestor's name or a pseudonym used. This would be of value where a particular Suggestor establishes a reputation which will enhance the likelihood of Shoppers purchasing the Suggestor's products, services, or other information.

Ways of Taking Suggestions

The suggestion can be taken by an automatic system wherein a user is shown a collection of products/services/content and the collection is taken as a suggestion. The suggestion is taken explicitly or implicitly by multiple means and sources. The Suggestor can click on a suggest link on a product shown in the suggestion website system of sites and/or give some information explicitly to register a suggestion. The Suggestor can simply browse through the products in the suggestion website and his/her browsing actions can be taken as suggestions. The suggestions can be taken in the form of a URL supplied by the Suggestor. The suggestion software automatically extracts the product attributes when supplied a URL as the suggestion. The Suggestor is shown the extracted attributes and properties for validation once they are extracted from the suggested page. The suggestion can also taken directly from the toolbar/button in the web browser of the Suggestor. The suggestion can be made from multi-modal and multi form factor devices like pocket PCs, cell phones, voice activated systems, kiosks etc.

Other Suggestion Software Features The software is activated when the user wants to give a suggestion. The suggestion software can be a server based (web based) system wherein the user does not have to install the client software in which case the user will have to explicitly supply information like URL, etc. and the software is activated by a frames or activeX based system in the user's web browsers. The software (client or server based) is a system which extracts the attributes of the product/service or content and shows them to the user explicitly for validation. If the suggestion website has an affiliate relationship with the suggested vendor/provider it informs the user of the compensation structure for the user in case his/her suggestion performs.

Affiliates

In one embodiment, for a Suggestor to be able to share in revenue, the link must be that of an affiliated vendor. An affiliated vendor is a qualified product, service, or other information vendor that has agreed to make a referral payment to the suggestion portal when a Shopper is referred by the portal to the vendor's products, service or other information. The referral payment can be based on actual purchases, clicks, or any other measurement mechanism. If the link is owned by someone that is not already an affiliate of the suggestion website, the acceptance of the suggestion is conditioned on the subsequent enrollment of the owner as an affiliate.

In one embodiment, the suggestion website signs up affiliates and has a data feed to populate the suggestion website with the product links of the affiliates. The product technical, commercial, and other information can be obtained as data feeds (ftp, email, downloads) in various formats from online vendors. Suggestors can then browse the suggestion portal to determine which of those links to suggest. Links that are suggested are marked or highlighted in some manner, so that future users can see that someone has suggested this product. In addition, the suggested links can be displayed first, or more prominently, for subsequent queries by other users.

The suggestion portal provides a medium for hosting, organizing and sharing users' suggestions with a plurality of prospective buyers. The suggestion portal provides a variety of search methods such as—tag search, product or service taxonomies, and user suggested hierarchies of tags and topics that are associated with various suggested products and services.

In an alternate embodiment, a Suggestor can browse other sites, and then submit links to the suggestion website. The suggestion website software will determine if the link belongs to an affiliate and is governed by an affiliate agreement. If not, an invitation to join the affiliate network may be sent to the link website, with acceptance of the suggestion conditioned on the website owner signing up as an affiliate.

Rewards

The client suggestion module enables a built-in reward mechanism that operates as follows: If a prospective buyer visits the suggestion portal and finds and buys an item or does something useful such as filling out a survey or contact form for a product or a service through a suggestion related tag or other descriptive annotation such as a review or comment, then the Suggestor is rewarded with compensation based upon the revenue derived from each such sale or action. Alternately, the reward could be derived from click through action on the suggested link related to a descriptive annotation such as a review or comment. The suggestion portal and the client suggestion module can communicate to deliver sale performance and reward information to the Suggestor.

The Suggestor could be informed of reward status by email or any other means. A personalized web page could be established for the Suggestor, with the suggestion web site software posting accumulated rewards for each suggestion. The Suggestor can view the performance of his/her suggestions and potential rewards. The rewards can be credits, coupons, cash or any other compensation. A policy may be established so that no reward is paid until a minimum or threshold amount is reached. The rewards could be tiered, so the Suggestor gets a larger incentive for more revenue generated.

A suggestion generates rewards by virtue of its performance (sales, click-throughs, impressions or otherwise) in different revenue channels. Any information given by the user which can generate revenue is a candidate suggestion, and the revenue generated through it is shared with the user who supplied that information.

In one embodiment, the invention uses a unique ID in the affiliate links as an identifier to track the Suggestor and tag associated with the product. The post-sales reports from affiliates reflect these IDs which are used to calculate the performance and rewards for the Suggestors.

Subsequent User Searching

Any Web Shopper visiting the suggestion portal can search the suggestions using a variety of methods, such as tag search or taxonomy and attribute guided navigation, to find a product or service offering matching his/her needs. If a Shopper purchases a suggested item, then the suggestion-portal earns a commission, a part of which is credited to the item's related Suggestor.

Ranking. The suggestion portal can rank the matching products based upon their click through traffic and sales statistics. The more highly ranked products are more prominently displayed. Administrative procedures can be implemented so that underperforming suggestions can be detected and eliminated. The suggestion portal tracks traffic and sales on each suggestion and can display appropriate visual information (histograms, gauges) to aid shoppers in their decisions.

The ranking can be done using any number of ways, including ranking by price, by sales, by click through rate, by alphabetical, by brand or any other technical or categorical dimension. Default views are provided to the user, with the user being given the ability to view other ranking methods. The most popular links can be grouped together in one area. Also, the most popular links corresponding to a particular tag (tag or tag combination) can be displayed as default when that tag is entered by a user.

Alternately, the ranking of products can be based on any number of factors instead of, or in addition to, traffic and sales. An algorithm could combine various factors in a way that minimizes gaming of the system. For example, buyers could rank matching products based on their Suggestors' past performance, or could fill out an evaluation of a Suggestor with information on the evaluation factored into the ranking (or a system like Ebay's personal rating system). If a Suggestor has a history of suggesting fewer products that sell a lot, then a buyer might prefer to see that star Suggestor's freshly suggested product sooner (i.e., before it takes time to perform). Various ways of ranking could be presented to the user, with the user being able to select which ranking or ranking combination to use. Or the Shopper could customize a page so the Shopper sees favorite Suggestors in addition to overall rankings.

In one embodiment, the suggestion portal ranks suggested products under a tag based on their Suggestors' past performance, so that a shopper can spot these freshly suggested products sooner (i.e., potentially before the time it takes for them to perform and become hot/popular products under this tag). The suggestion website can also group the products listed under a tag by their Suggestors, so that a Shopper can see all suggestions of an expert or like-minded Suggestor altogether. Additionally, users can be given the ability to see all suggestions of an expert/like-minded Suggestor under all tags. This would be like exploring the “private shop” of a Suggestor. Power Suggestors can name their shops as a perk.

In one embodiment, the pages of the suggestion website initially will have the suggestions ranked by their performance. The user will have the option to set a preferred mode of presentation. The web pages will include in various embodiments guides, parametric search input boxes, context breadcrumb links, guides and other features to enhance usability.

Other features of Suggestion Software

Suggestor features. The Suggestor can (1) make suggestions; (2) see if the product is available with the suggestion website; (3) see a list of the tags relevant to a particular product suggestion; (4) organize and move related tags; (5) post and participate in a forum: (6) suggest related products; (7) track suggestion performance through a detailed report of how much traffic and conversion the user's suggestions attracted; (8) register and provide address and related info for receiving updates and suggestion rewards; (9) send suggestions to individuals or a closed group of individuals.

Product listing features. The software for displaying products can (1) group products on suggestions by their tag; (2) bring in new products through the data feeds provided by the vendors; (3) receive new product suggestions from affiliated vendors; (4) aggregate a list of unaffiliated vendors and products for processing after taking suggestions from unaffiliated vendors; (5) set up data-feed processing automation for including products after a vendor affiliation; (6) track product performance ( traffic and conversion ); (7) take off discontinued or out-of stock items after customer flagging or vendor discontinuation; (8) incorporate new products or refresh existing product data without disturbing existing rankings; (9) track the pages to get the most sticky hot pages.

Orders. The software for handling orders can (1) incorporate the affiliate network (Commission Junction, LinkShare) reports into the reporting structure; (2)lntegrate the sales data with the user suggestion data; (3) provide visibility to the sales reports in terms of suggestions; (4) incorporate and translate sales into user rewards.

Payments. Payment software functions to (1) reimburse users for their suggestions; (2) set-up the minimum reward thresholds; (3) establish rewards programs to multiply the potential rewards for the users; (4) incorporate time delay to account for the user-returns.

Advertisers. Advertising software can (1) provide the advertisers with a comprehensive report of the pages in their domain; (2) provide a cost model to charge more for the heavy traffic and high conversion pages; (3) provide the advertisers with a pricing chart for the phrases they want to target.

Browser Button. The browser button software provided to a potential Suggestor can (1) sense the product in a page and its important attributes; (2) get the data validated by the user match it with the suggestion database and register the suggestion after taking in the relevant tags. The browser button software in one embodiment takes a snapshot of the HTML page DOM model, ad-hoc, on form post-backs (i.e., when a user fires searches—fills up the keyword query in search boxes). The software intercepts the data before it is submitted to the servers. The software inspects the DOM and extracts the keyword queries to be presented as candidate tags at the time of suggestion submission.

Suggestion Website Software Modules

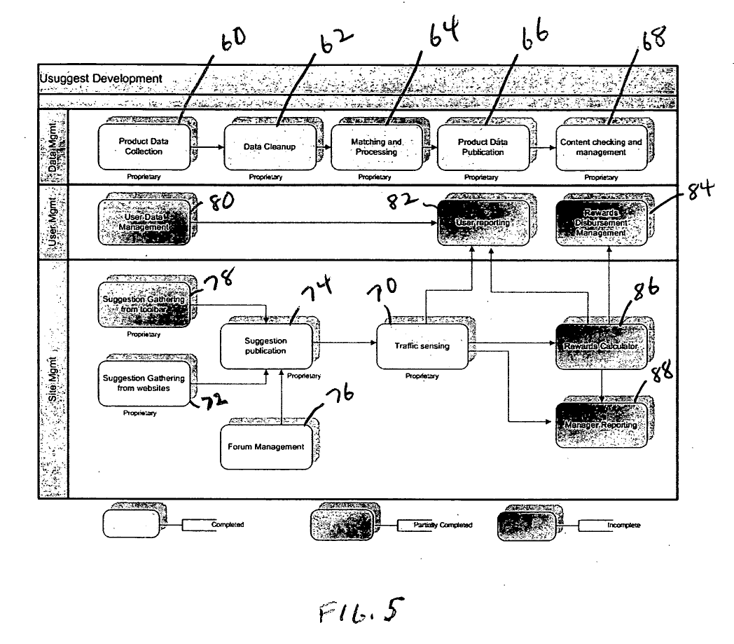

FIG. 5 illustrates one embodiment of the modules of the software at the suggestion website.

A Product Data Collection module 60 manages the automatic collection and aggregation of product data from the affiliated online vendors. Tags and hot tag phrases are obtained from various sources such as Google and Word Tracker. Data collection is done with the help of vendor supplied data feeds and web data extraction technologies. A Data Cleanup module 62 manages cleaning up the raw product data from different sources into a uniform data format that the website uses in subsequent data processing stages. Matching and Processing module 64 manages preparing data for the ‘tagged’ raw product pages from which the Suggestors will suggest products. Keyword matching is used for automatically bootstrapping the suggestion website tagged product pages. However, tag matching products are always kept separate from the suggested products.

Product Data Publication module 66 publishes the raw tagged pages with the correct hyper linking and taxonomy organization in a specified design template. Content checking and management module 68 is a set of automated tools given to the data operators and site maintenance staff to ensure the product variety and relevance on the suggestion website shopping pages. Traffic Sensing module 70 actively monitors the traffic on the suggestion and dynamically ranks the suggestion based on their performance. This module accounts for every click in the suggestion website and is responsible for extensive user profiling. Suggestion Collection module 72 handles suggestion collection from the suggestion website.

Suggestion Publication module 74 does the data cross checking, tagging and affiliate check of the suggestion and publishes it in the appropriate tag page. Forum Management module 76 is responsible for managing the user conversation threads in the suggestion pages. Suggestion Collection Button on Browser module 78 gives the users a browser button to send the suggestions to the suggestion website from anywhere on the web. User Data Management module 80 manages the user information including emails, login IDs, addresses, alias, etc. User Reporting module 82 is a web based reporting system for the Suggestors where they can view the performance of their suggestions and potential rewards. Rewards Disbursement Management module 84 is responsible for generating the final reward reimbursement medium (checks, credit vouchers etc). Rewards Calculation module 86 is responsible for sales data collection and calculation of rewards based on that data. Administrative Reporting and Management module 88 is responsible for generating the revenue reports, administrative data, performance summaries and strategic reports for power Suggestors and the suggestion website administrators and marketers.

Friends family forums: Spheres of influence. A Suggestor can form different groups to share suggestions with. When the Suggestor submits a suggestion, it will also be sent to any groups, through email or any other means, designated by the Suggestor. Even if a suggestion is rejected as already having been suggested, it can still be sent to these groups from the Suggestor and the Suggestor can earn rewards if anyone in their referral network acts on the suggestion.

Multi-modal accessibility for deal validation. Each individual's referral database is accessed via the website regardless of information channel (home computer, work computer, web phone). The suggestion website hosts all the services and suggestions via (a multi-modal) website. Online/offline deals can be validated through a cell phone or other mobile device. A user can call the suggestion website with a mobile device while shopping. The user can text message, or speak to a VRU and tell the database about the great deal the user just found, or check to see if other Suggestors think it is a great deal, or have found better deals.

Off-line and local suggestions. In one embodiment, a Suggestor can get rewards for offline purchases or visits. Other people in the Suggestor's affinity group would get email, voice mail or a text message letting them know about the deal. Those group members could then go to the retail store, and tell the clerk how they were referred. In some embodiments, a coupon would be sent with the referral, which the person could print and take to the store. The coupon would have an ID that indicated the Suggestor. Alternately, the coupon or referral could be in a text message which could be read at the POS, either with a scanner or wirelessly. Retail partners that have agreed to this arrangement would then provide a reward of some type to the Suggestor.

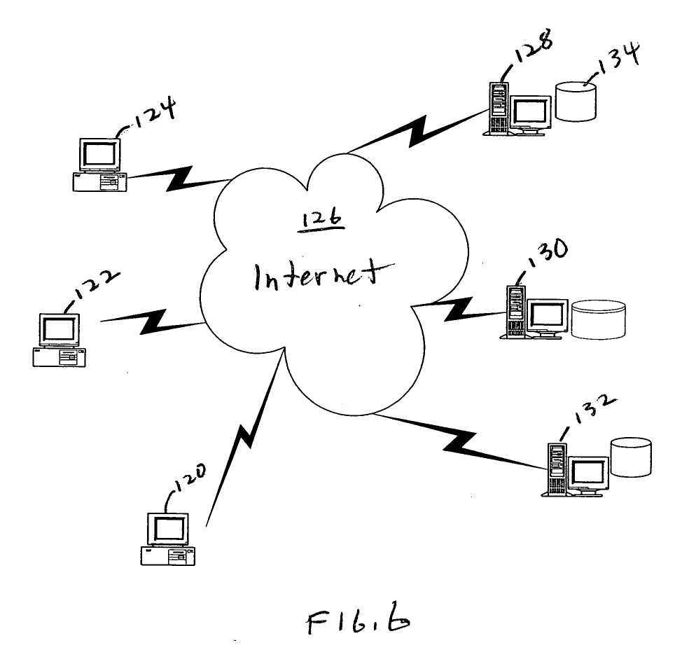

FIG. 6 is a diagram of an embodiment of the interaction of a Suggestor at a Suggestor computer 120 and Shoppers at Shopper computers 122, 124 over the Internet 126 with the Suggestion website server 128. The Suggestors may also browse, for example, at an individual site on a server 130 or a shopping mall on a server 132. Associated with suggestion website server 128 is memory storage 134 for storing the tags, links and Suggestor information, along with other data described herein. One implementation of a database on storage 134 is a relational database model to maintain the relationship data (where the tuples consist of <Key, Tag, User ID, Item ID>). Alternately, suggestions can be implemented as an inverted list of tags mapping to the items in the database. Any other database storage structure could also be used.

As will be understood by those of skill in the art, the present invention could be embodied in other specific forms without departing from the essential characteristics thereof. For example, the Suggestor could suggest articles or information rather than products or services. The incentive could be non-monetary, such as recognition for political volunteers who get the word out and find favorable coverage for their candidate. Alternately, a salaried group of Suggestors could be employed.

Alternately, a Suggestor can make suggestions over mobile cell phones and other similar devices that do not use the Internet. For example, they may just dial an 800 number or use a satellite network etc. Also, a shopper may access the suggestion database directly using an 800 number, etc., without ever accessing the web site or internet. Bar-code decoding & comparative shopping can be done via camera cell phones or voice activation or keypad entry of tags, allowing a Shopper in a real store to compare items in the store with suggestions on the database. Off-line and local suggestions can be posted, and offline users can receive suggestion information through other channels in order to validate an offline shopping decision using a variety of communication devices and networks Accordingly, the foregoing embodiments are intended to be illustrative, but not limiting, of the scope of the invention which is set forth in the appended claims.

What is claimed is:

1. A method for providing suggested information, comprising:
storing, at a suggestion portal, suggested information recommended by a plurality of Suggestors;
storing, in association with said suggested information, at least one corresponding tag provided by a corresponding one of said Suggestors; and
accessing said suggested information by a subsequent user upon entry of said corresponding tag or tags by said subsequent user.

2. The method of claim 1 wherein said suggested information is a suggested link on the Internet.

3. The method of claim 1 further comprising:
rewarding said one of said Suggestors when said subsequent user performs a predefined action in connection with accessing suggested information suggested by said one of said Suggestors.

4. The method of claim 1 further comprising:
storing an identification of said Suggestors in association with said corresponding tag and information.

5. The method of claim 1 further comprising:
rewarding said one of said Suggestors only when said Shopper accesses suggestion information suggested by said Suggestor using a corresponding tag suggested by said Suggestor.

6. The method of claim 1 further comprising:
obtaining a plurality of links from affiliates;
browsing said suggestion website by a Suggestor; and
recommending one of said links by said Suggestor.

7. The method of claim 1 further comprising:
tracking tags used by said Suggestor browsing sites other than said suggestion portal; and
recommending a link by said Suggestor during said browsing.

8. The method of claim 1 further comprising:
providing a list of possible tags, related to said corresponding tags, to said Suggestor;
associating with said suggestion information ones of said possible tags indicated by said Suggestor.

9. The method of claim 1 further comprising;
prompting a Suggestor to submit opinions, reviews, coupons, or other comments or relevant information related to suggested information.

10. The method of claim 1 further comprising;
prompting a Suggestor to submit additional links related to suggested information

11. The method of claim 1 further comprising;
prompting a Suggestor to select at least one category for suggested information

12. The method of claim 1 further comprising;
prompting a Suggestor to designate individuals or groups of individuals to receive suggested information

13. The method of claim 1 further comprising ranking said suggested information on said suggestion website.

14. The method of claim 1 further comprising maintaining the privacy of said Suggestors by concealing the identity of said Suggestors from other users.

15. The method of claim 1 further comprising obtaining product description information from a web page of suggested information.

16. The method of claim 14 further comprising highlighting relevant information on said web page by said Suggestor.

17. The method of claim 14 further comprising comparing said product description information with affiliate catalog information regarding said product.

18. The method of claim 1 further comprising adding a suggestion button on a browser of said Suggestor, said suggestion button accessing a suggestion submission module on said suggestion website upon clicking said browser button by said Suggestor.

19. The method of claim 1 wherein said suggested information is provided to said suggestion portal over a communication link other than the Internet.

20. The method of claim 19 wherein said communication link is one of a telephone network or a satellite network.

21. The method of claim 1 wherein said subsequent user accesses said suggestion portal over a communication link other than the Internet.

22. The method of claim 1 further comprising:
inputting information regarding products in a physical store using a mobile device; and
comparing said information with suggestion information on said suggestion portal.

23. The method of claim 22 further comprising:
inputting said information through one of bar-code scanning, voice activation entry of tags or keypad entry of tags.

24. An apparatus for providing suggested links over the Internet, comprising:
a suggestion server;
a storage device coupled to said suggested server to store suggested links recommended by a plurality of Suggestors;
said storage device storing, in association with each of said suggested links, at least one corresponding tag provided by a corresponding one of said Suggestors; and
a software program stored on computer readable media providing code for accessing one of said suggested links for a subsequent user upon entry of said corresponding tag by said subsequent user.

25. The apparatus of claim 18 further comprising:
a reward module, coupled to said server, configured to reward said one of said Suggestors when said subsequent user performs a predefined action in connection with accessing a link suggested by said one of said Suggestors.

26. The apparatus of claim 18 further comprising:
a tracking module, added to a browser of said Suggestor, for tracking tags used by said Suggestor browsing sites other than said suggestion website; and
a recommendation module, associated with said tracking module, for enabling the recommending of a link by said Suggestor during said browsing.

27. A method for providing suggested links over the Internet, comprising:
storing, at a suggestion website, suggested links recommended by a plurality of Suggestors;
storing, in association with each of said suggested links, at least one corresponding tag provided by a corresponding one of said Suggestors;
accessing one of said suggested links for a subsequent user upon entry of said corresponding tag by said subsequent user;
rewarding said one of said Suggestors when said subsequent user performs a predefined action in connection with accessing a link suggested by said one of said Suggestors;
storing an identification of said Suggestors in association with said corresponding tag and link;
obtaining a plurality of links from affiliates;
browsing said suggestion website by a Suggestor;
recommending one of said links by said Suggestor tracking tags used by said Suggestor browsing sites other than said suggestion website; and
recommending a link by said Suggestor during said browsing.
